(19) United States
(12) Patent Application Publication
(10) Pub. No.: US 2026/0294164 A1
(43) Pub. Date: Oct. 1, 2026

(54) FONDUE ASSEMBLY AND ADAPTER RING

(71) Applicant: GESTION ADCI INC., Saint-Victor (CA)

(72) Inventor: Dany Bernard, Saint-Victor (CA)

(21) Appl. No.: 19/480,729

(22) PCT Filed: May 3, 2024
(86) PCT No.: PCT/CA2024/050603

§ 371 Date: Oct. 31, 2025

Related U.S. Application Data
(60) Provisional application No. 63/499,812, filed on May 3, 2023.

(51) Int. Cl. A47J 36/20

(52) U.S. Cl. CPC A47J 36/20

(57) ABSTRACT

A fondue assembly is provided and includes a heating device operable to generate heat and a fondue pot adapted to be mounted on the heating device for receiving heat therefrom. The fondue pot has a peripheral wall provided with a lip defined at a top edge thereof. The fondue assembly also includes an adapter ring connectable to the fondue pot and which includes a ring body adapted to engage the lip and a locking mechanism operatively coupled to the ring body. The locking mechanism is operable between a locked configuration, where movement of the ring body relative to the fondue pot is blocked, and an unlocked configuration. The fondue assembly has at least one basket adapted to cooperate with at least one of the adapter ring and the fondue pot in order to be positioned in a predetermined position.

### TECHNICAL FIELD

The technical field generally relates to a fondue assembly, and more particularly to a fondue assembly having an adapter ring.

### BACKGROUND

Fondue is a dish generally consisting of a hot liquid in a heated pot, where bite-sized pieces of food are dipped into the hot liquid, typically with the use of two-pronged forks. Various meats, vegetables and fruits, for example, may be dipped into bouillon, melted cheese or chocolate. Since fondue is generally eaten by a group of people, bite-sized pieces of food from each person may over encumber and/or fall into the heated pot, making it both difficult to retrieve and causing it to potentially be mixed with others' food.

It would be useful to be able to provide an improved assembly which would be able to overcome or at the very least minimize some of known drawbacks and/or deficiencies associated with conventional fondue devices/assemblies.

### SUMMARY

According to an aspect, a fondue assembly is provided. The fondue assembly includes a heating device operable to generate heat, a fondue pot adapted to be mounted on the heating device for receiving heat therefrom, the fondue pot having a peripheral wall provided with a lip defined at a top edge thereof; an adapter ring adapted to be coupled to the fondue pot. The adapter ring includes a ring body having a generally U-shaped cross-section with an inner ring section and an outer ring section, the ring body being adapted to engage the top edge of the fondue pot to position the inner ring section within the fondue pot and to position the outer ring section along an outside of the fondue pot; and a locking mechanism operatively coupled to the ring body and comprising a locking element operable between a locked configuration, where the locking element engages the lip of the fondue pot to secure the ring body to the fondue pot, and an unlocked configuration, where the locking element disengages the lip of the fondue pot to enable movement of the ring body relative to the fondue pot. The fondue assembly also includes at least one basket adapted to cooperate with at least one of the adapter ring and the fondue pot in order to be positioned in a predetermined position.

According to an embodiment, the lip extends from the peripheral wall at an angle between about 60 degrees and about 120 degrees.

According to an embodiment, the lip extends outwardly from the peripheral wall, and the outer ring section of the ring body overhangs the lip, and wherein the locking element is provided along the outer ring section of the ring body.

According to an embodiment, the locking element comprises a clip pivotally connected to the ring body along the outer ring section, the clip includes a projection extending from a rear side thereof, and wherein the clip is operable between an open position, where the projection is spaced from the lip, and a closed position, where the projection engages the lip from below to prevent upward movement of the ring body relative to the fondue pot.

According to an embodiment, the outer ring section includes a plurality of clip openings, and the locking mechanism comprises a plurality of clips pivotally coupled to the outer ring section in respective clip openings.

According to an embodiment, each clip comprises a latching protrusion, and each clip opening comprises a catching protrusion, the latching protrusion being configured to cooperate with the latching protrusion to releasably secure the corresponding clip in the closed position.

According to an embodiment, the clip is adapted pivot downwardly from the open position to the closed position.

According to an embodiment, the clip comprises a recessed portion proximate a bottom end thereof, and wherein, when the clip is in the closed position, the recessed portion is spaced from the peripheral wall.

According to an embodiment, the clip comprises a blocker extending from the rear side thereof and adapted to engage the peripheral wall of the fondue pot when the clip is in the closed position, the blocker being configured to at least partially block rotational movement of the ring body relative to the fondue pot when engaging the peripheral wall.

According to an embodiment, the blocker comprises at least one resilient element configured to apply a compressive force on the peripheral wall when the clip is in the closed position.

According to an embodiment, the at least one resilient element is adapted to at least partially flex upon applying the compressive force on the peripheral wall and revert to an initial shape when the clip is moved to the open position.

According to an embodiment, the blocker comprises a pair of resilient elements adapted to flex in respective directions upon applying the compressive force.

According to an embodiment, the pair of resilient elements extend parallel to one another and perpendicularly from the rear surface of the clip.

According to an embodiment, the pair of resilient elements are adapted to flex in opposite directions away from one another.

According to an embodiment, the ring body comprises at least one holding section, and wherein the at least one basket comprises a handle adapted to cooperate with the at least one holding section to retain the basket in the predetermined position.

According to an embodiment, the at least one holding section comprises a recess having a top portion defined on a top surface of the ring body, and wherein the handle is at least partially confined to the recess when in the predetermined position.

According to an embodiment, the recess comprises a lateral portion defined along the outer ring section, and wherein the handle comprises a tab extending therefrom and adapted to engage the lateral portion of the recess to prevent movement of the basket radially inwardly within the fondue pot.

According to an embodiment, the inner ring section comprises at least one socket, and wherein the at least one basket comprises a hook member provided proximate a bottom of the basket and configured to engage the socket to position the basket in an elevated position.

According to an embodiment, the inner ring section comprises a double-wall assembly defining a groove extending along an inner surface of the peripheral wall, the at least one socket being defined along the double-wall assembly and opening opposite the groove.

According to another aspect, a fondue assembly is provided. The fondue assembly includes a heating device operable to generate heat; a fondue pot adapted to be mounted on the heating device for receiving heat therefrom, the fondue pot having a peripheral wall provided with a lip defined at a top edge thereof; an adapter ring connectable to the fondue pot, the adapter ring comprising: a ring body adapted to engage the lip; and a locking mechanism operatively coupled to the ring body and being operable between a locked configuration, where the locking mechanism at least partially blocks movement of the ring body relative to the fondue pot, and an unlocked configuration; at least one basket adapted to cooperate with at least one of the adapter ring and the fondue pot in order to be positioned in a predetermined position.

According to an embodiment, the locking mechanism comprises an axial locking element configured to at least partially block movement of the ring body along a centerline axis thereof relative to the fondue pot when the locking element is in the locked configuration.

According to an embodiment, the locking mechanism comprises a rotational locking element configured to at least partially block rotational movement of the ring body relative to the fondue pot.

According to another aspect, an adapter ring for a fondue pot having an outwardly extending lip is provided. The adapter ring includes a ring body connectable to the fondue pot and having an outer portion adapted to engage and overhang the lip; and a locking mechanism operatively coupled to the ring body and comprising a locking element provided along the outer portion, the locking element being operable between a locked configuration, where the locking element engages the lip of the fondue pot to secure the ring body to the fondue pot, and an unlocked configuration, where the locking element disengages the lip of the fondue pot to enable movement of the ring body relative to the fondue pot.

According to an embodiment, the ring body is a single monolithic piece.

According to an embodiment, the outer portion is adapted to overhang the top edge of the fondue pot and define a space between the outer portion and the fondue pot, the space being sized to enable insertion of a finger therein to facilitate gripping the ring body.

According to an embodiment, the outer portion comprises an opening defined along a length thereof, and the locking element is pivotally connected to the ring body within the opening and is pivotable between the locked and unlocked configurations.

According to an embodiment, the locking element comprises a clip having a substantially planar body pivotally connected to the ring body at a first end thereof and a projection extending from the planar body towards the inner portion, and wherein, upon coupling the adapter ring to the fondue pot, the clip is pivotable between an open position to operate the locking element in the unlocked configuration to space the projection from the fondue pot and allow disconnection of the adapter ring therefrom, and a closed position to operate the locking element in the locked configuration to position the projection in engagement with the fondue pot to prevent upward movement of the ring body relative to the fondue pot.

According to an embodiment, the clip comprises at least one latching protrusion extending proximate a side of the planar body, and the outer portion comprises a catching protrusion extending into the opening and configured to receive and connect with the latching protrusion to releasably secure the clip in the closed position.

According to an embodiment, the opening comprises a pair of catching protrusions extending therein from opposite sides thereof, and the clip comprises a pair of latching protrusions extending from opposite sides of the planar body.

According to an embodiment, the clip comprises a blocker extending from the rear side of the planar body and adapted to engage the fondue pot when in the closed position, the blocker being configured to at least partially block rotational movement of the ring body relative to the fondue pot when in the closed position.

According to an embodiment, the blocker comprises at least one resilient element configured to apply a compressive force on the fondue pot when the clip is in the closed position to at least partially block rotational movement of the ring body relative to the fondue pot.

According to an embodiment, the at least one resilient element is adapted to at least partially flex upon applying the compressive force on the fondue pot and revert to an initial shape when the clip is moved to the open position.

According to an embodiment, the blocker comprises a pair of resilient elements adapted to flex in respective directions upon applying the compressive force.

According to an embodiment, the pair of resilient elements extend parallel to one another and perpendicularly from the rear surface of the planar body.

According to an embodiment, the pair of resilient elements are adapted to flex in opposite directions away from one another.

According to an embodiment, the locking mechanism comprises a plurality of locking elements distributed along a perimeter of the ring body

According to an embodiment, the ring body comprises at least one of recesses defined along a top surface thereof adapted to receive a portion of respective fondue baskets and sockets defined along the inner portion and adapted to receive a hook member of respective fondue baskets.

According to another aspect, a kit for a fondue assembly is provided. The kit includes a heater; a fondue pot having an outwardly extending lip; an adapter ring as defined above; and at least one basket.

### BRIEF DESCRIPTION OF THE DRAWINGS

FIG. 1 is a perspective view of a fondue assembly, according to an embodiment.

FIG. 2 is an exploded view of the fondue assembly shown in FIG. 1, showing the various different components of the fondue assembly, according to an embodiment.

FIG. 3 is a top perspective view of a fondue pot of the fondue assembly shown in FIG. 1, showing the fondue pot provided with an adapter ring, according to an embodiment.

FIG. 3A is an enlarged view of a clip of the adapter ring shown in FIG. 3, the clip being configured to engage a lip of the fondue pot, according to an embodiment.

FIGS. 4A and 4B are cross-sectional views of the fondue pot provided with the adapter ring as shown in FIG. 3, showing the clip in a closed position (FIG. 4A) and in an open position (FIG. 4B), according to possible embodiments.

FIG. 5 is a bottom perspective view of the fondue pot shown in FIG. 3, showing a clip in the open position, according to an embodiment.

FIG. 5A is an enlarged bottom perspective view of the clip shown in FIG. 5, showing a latch and catch assembly for holding one of the clips in the closed position, according to an embodiment.

FIG. 6 is a bottom view of the fondue pot and adapter ring of the fondue assembly of FIG. 1, showing one of four clips in the open position, according to an embodiment.

FIG. 6A is an enlarged bottom view of the open clip shown in FIG. 6, showing a blocker configured to engage a sidewall of the fondue pot, according to an embodiment.

FIG. 7 is a side elevation view of a basket of the fondue assembly shown in FIG. 1, according to an embodiment.

### DETAILED DESCRIPTION

As will be explained herein in relation to various embodiments, a fondue assembly or fondue set is provided. The fondue assembly generally includes a heater or heating device, a fondue pot adapted to sit on the heater and defining an inner volume, an adapter ring selectively connectable to the fondue pot, and a plurality of fondue baskets. The adapter ring is configured to define holding sections about a periphery of the fondue pot (e.g., along a perimeter thereof), and each basket includes a handle shaped and configured to cooperate with the adapter ring to engage a corresponding one of the holding sections. The baskets are shaped and adapted to hold various items therein (e.g., meat, vegetables, fruits, etc.) and at least partially enter the inner volume of the fondue pot. As will be described further below, the holding sections are evenly distributed about the fondue pot periphery such that the baskets are correspondingly evenly distributed within and around the fondue pot.

The adapter ring includes a ring body (e.g., a circular body) shaped and adapted to connect to a top edge of the fondue pot. In other words, the adapter ring extends along a rim or top edge of the fondue pot, thereby providing the holding sections at regular intervals about the top edge of the fondue pot. As such, the baskets can be positioned within the fondue pot, with their respective handles engaging the adapter ring and extending past the top edge to facilitate manipulation. The adapter ring includes an outer ring section configured to engage an outer surface of the fondue pot when connected thereto. The outer ring section includes a plurality of clips operable between locked and unlocked configurations to selectively secure the adapter ring to the fondue pot. The clips are thus operable from outside the fondue pot, thereby facilitating operation thereof, which correspondingly makes it easier to connect and disconnect the adapter ring.

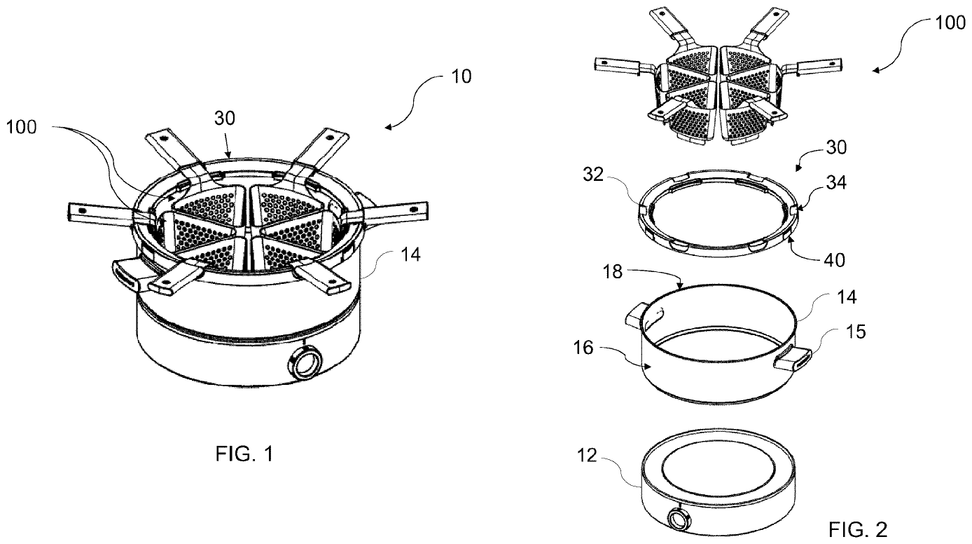

Referring to FIGS. 1 and 2, an embodiment of a fondue assembly 10 is shown. The fondue assembly 10 includes a heating device or heater 12, a pot, such as a fondue pot 14, a fondue pot adapter ring 30 (or simply “adapter ring”), and one or more baskets 100. Broadly described, the fondue pot 14 is adapted to be received on (e.g., sit on) the heater 12, which is operable to generate heat in order to heat, melt and/or cook the contents of the fondue pot 14. As will be further described below, the adapter ring 30 is adapted to be coupled to the fondue pot 14, such as to a top edge thereof. The baskets 100 are shaped and configured to be placed within the fondue pot 14, and are adapted to cooperate with the adapter ring 30 for positioning the baskets in desired and/or predetermined positions.

In some embodiments, the heater 12 is an electric heating device, although it is appreciated that other types of heaters are possible and may be used. The heating device may, for example, include various different heating settings to enable adjustments of the heat generated by the heater, for example, depending on the requirements of the food to be heated and/or melted in the pot 14. The pot 14 can include one or more handles 15 made of a low-conductivity material, such as plastic, to allow safely handling the fondue pot 14.

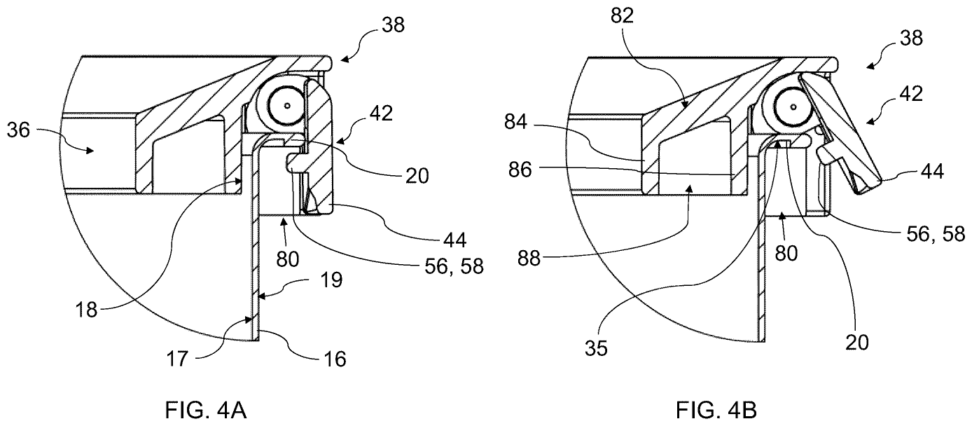

In this embodiment, the fondue pot 14 can correspond to any known and/or traditional fondue pot (also referred to as a caquelon pot) having any suitable size and/or shape. For example, standard fondue pots are generally circular, and have sizes ranging between 20 cm and 30 cm in diameter. In the illustrated embodiment, the fondue pot 14 includes a circumferentially extending sidewall 16 (or peripheral wall) having a top edge or top portion 18 provided with a lip 20. As seen in FIGS. 4A and 4B, the lip 20 can extend at an angle relative to the sidewall 16. In this embodiment, the lip 20 and the sidewall 16 define an angle between about 60 degrees and 120 degrees, such as about 90 degrees. However, it is appreciated that any other suitable sizes, shapes and/or configurations are possible, and may be used for the fondue pot 14 and associated parts.

Still referring to FIGS. 1 and 2, the adapter ring 30 is adapted to be coupled to the fondue pot 14. More specifically, the adapter ring 30 has a ring body 32 having a generally circular shape and adapted to be connected to the top edge 18 of the fondue pot. As will be described further below, the ring body 32 includes holding sections 34 configured to enable the baskets 100 to cooperate with the ring body 32 to at least partially secure the baskets 100 in respective desired and/or predetermined positions. The adapter ring 30 also includes a locking mechanism 40 selectively operable to secure the ring body 32 to the fondue pot 14. The locking mechanism 40 can be operated between an unlocked configuration, where movement of the adapter ring 30 relative to the fondue pot 14 is allowed, and a locked configuration, wherein movement of the adapter ring 30 relative to the fondue pot 14 is prevented, or at least obstructed and/or restricted.

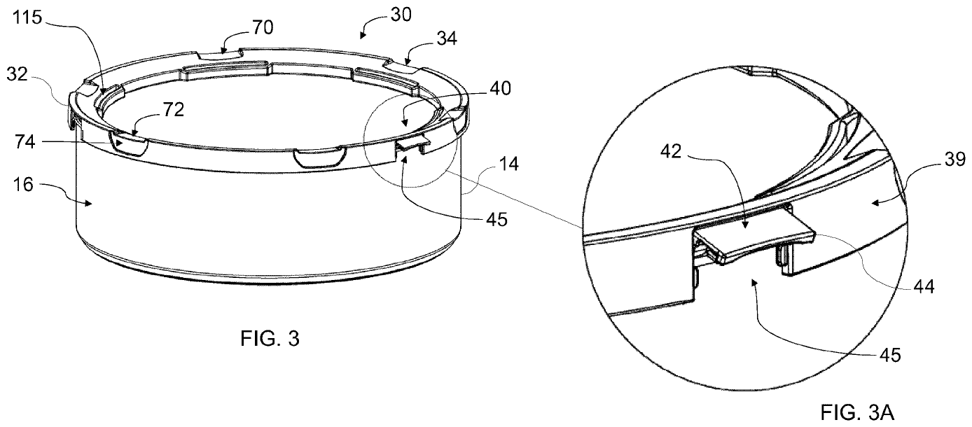

With reference to FIGS. 3 to 4B, in addition to FIGS. 1 and 2, in some embodiments, the ring body 32 can have a generally U-shaped cross-section and is adapted to engage the top edge 18 of the fondue pot. More particularly, the ring body 32 can include an inner ring section 36 and an outer ring section 38 cooperating to form a recess 35 therebetween. In this embodiment, the recess 35 is shaped and sized to receive the sidewall 16 therein, such as the top edge 18 and the lip 20. As such, the ring body 32 can engage or “sit” on the top edge of the sidewall. As seen in FIGS. 4A and 4B, when the ring body 32 engages the sidewall, the inner ring section 36 is adapted to at least partially extend along an inner surface 17 of the fondue pot 14 (e.g., within the fondue pot). Similarly, the outer ring section 38 is adapted to at least partially extend along an outer surface 19 of the fondue pot.

In some embodiments, the inner and outer ring sections 36, 38 are generally parallel to one another and extend on opposite sides of the sidewall 16. However, it is appreciated that other configurations are possible, such as having at least one of the inner and outer ring sections extending at an angle relative to the sidewall and/or to the other one of the inner and outer ring sections, for example.

In this embodiment, the locking mechanism 40 of the adapter ring 30 is provided along the outer ring section 38 to enable operation thereof from outside the fondue pot. It is thus noted that the location of the locking mechanism 40 provides ease of access which can facilitate operation thereof. As seen in FIGS. 3 to 4B, the locking mechanism 40 includes one or more clips 42 provided about the ring body 32, and more specifically about the outer ring section 38. The clips 42 are operable between a closed or locked position (seen in FIG. 4A) and an open or unlocked position (seen in FIG. 4B) to correspondingly operate the locking mechanism 40 between the locked and unlocked configurations.

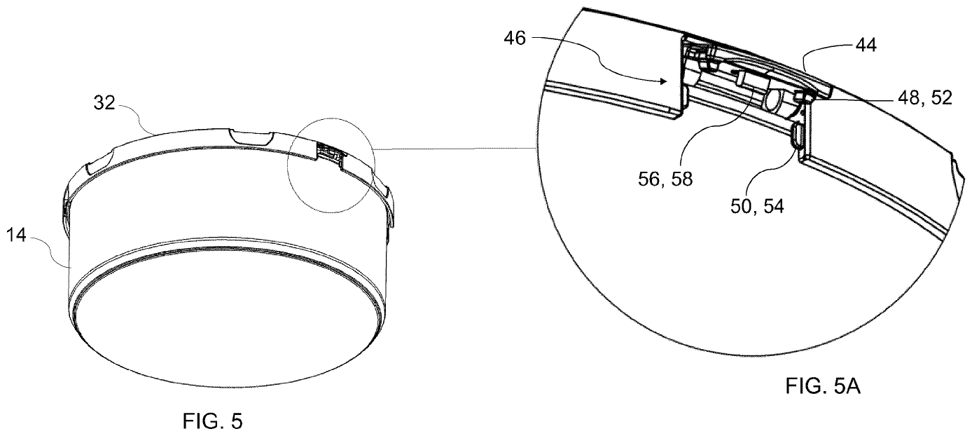

It is noted that the outer ring section 38 defines an outer ring surface 39 extending circumferentially about the ring body 32. In some embodiments, the clips 42 can form part of the outer ring surface 39 such that, when the clips 42 are in the closed position, the outer ring surface 39 is generally continuous around the ring body 32. As illustrated in FIGS. 3, 3A, 5 and 5A, the outer ring section 38 can include clip openings defined as notches or gaps 45 along the outer ring surface 39. Each gap 45 is shaped and sized to receive one of the clips 42 of the locking mechanism therein, and enable operation thereof between the open and closed positions. In some embodiments, each clip 42 can include a clip body or tongue 44 pivotally connected to the ring body 32 within respective gaps 45. The tongue 44 can thus pivot between the open and closed positions. It should be noted that the tongues 44 are manually and independently pivotable and are thus selectively operable between the open and closed positions. However, it is appreciated that other configurations are possible, such as having each clip 42 be operatively coupled to one another such that pivoting one clip correspondingly pivots the other clips, for example.

With reference to FIGS. 4A to 6A, in this embodiment, each clip 42 can include a latch and catch assembly or simply “latch” 46 configured to retain the tongue 44 in the closed position. The latch 46 can include a tongue portion 48 and a ring portion 50 adapted to cooperate with one another when the tongue is in the closed position to prevent undesired or accidental opening of the clip. As seen in FIG. 5A, the tongue portion 48 can include a pair of latching protrusions 52, while the ring portion 50 can include a pair of catching protrusions 54. The latching protrusions 52 are adapted to engage with respective catching protrusions 52 to releasably couple the tongue to the ring body 32 in the closed position. It should be understood that the tongue 44 can be moved from the closed position to the open position by applying sufficient force to disengage the latching protrusions 52 from the catching protrusions 54, thereby enabling unhindered pivotal movement of the tongue 44.

In this embodiment, each clip 42 further includes an engagement member 56 configured to engage with the fondue pot 14 when the tongue 44 is in the closed position. The engagement member 56 is configured to prevent disconnection of the adapter ring 30 from the fondue pot 14. In some embodiments, the engagement member 56 includes a projection 58 extending from a back side of the tongue 44 and adapted to be positioned below the lip 20 when in the closed position (seen in FIG. 4A). The projection 58 can be configured to hook onto the lip 20, thereby locking the tongue 44 thereto, and therefore locking the ring body 32 to the fondue pot 14. Alternatively, the projection 58 can simply be positioned below the lip 20 and adapted to prevent disengagement of the ring body 32 from the fondue pot 14, for example, by lifting the ring body 32. It should thus be understood that the engagement member 56 can be configured to block axial (e.g., vertical) movement of the adapter ring 30.

It is noted that the latch 46 and the engagement member 56 cooperate together to prevent disconnection of the adapter ring 30. More particularly, the latch 46 is configured to maintain the tongue 44 in the closed position, and the engagement member 56 is configured to prevent disconnection of the adapter ring 30 as long as the tongue is in the closed position. In this embodiment, the tongue 44 can be provided with a recessed portion 59 on the back side to facilitate gripping the tongue 44 for applying the sufficient force to open it. In other words, the recessed portion 59 can facilitate inserting a tool or a finger between the tongue and the fondue pot for pulling on and opening the tongue. It is appreciated that, when in the open position (seen in FIG. 4B), the projection 58 is clear from the lip 20, thus enabling the ring body 32 to be disconnected and removed from the fondue pot.

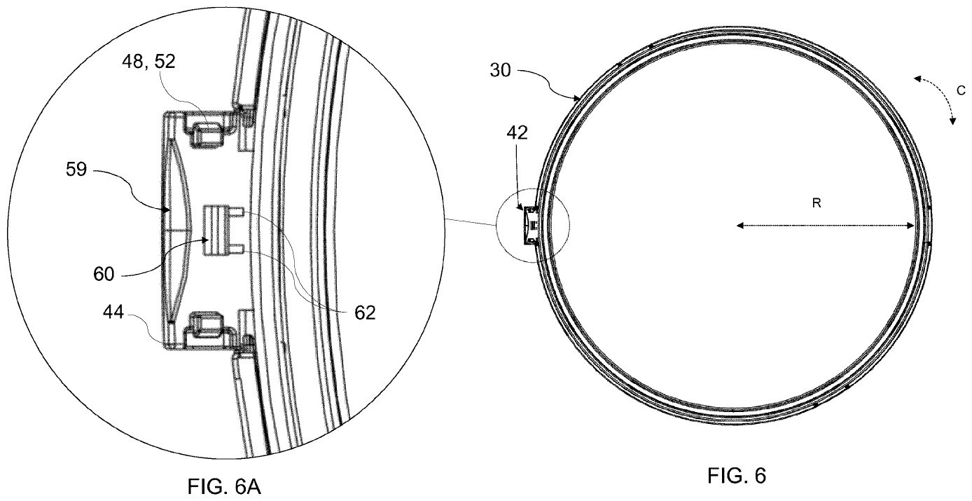

As seen in FIGS. 6 and 6A, each clip 42 can include a blocker element (or simply “blocker”) 60 configured to engage the fondue pot 14 and block at least a rotational movement of the adapter ring relative to the fondue pot. In this embodiment, the blocker 60 includes one or more resilient element 62 adapted to engage with and apply a compressive force on the fondue pot 14 to secure the ring body 32 relative to the fondue pot. The one or more resilient element 62 can extend from the back side of the tongue 44 to engage the sidewall 16 when the tongue is closed. The resilient elements can be made of material having a high coefficient of friction, such as rubber, for example, to block relative motion between the pot and the adapter ring.

As seen in FIG. 6A, the one or more resilient elements 62 can include a pair of resilient elements 62 extending perpendicularly from the tongue and parallel to one another. The resilient elements 62 are adapted to deform upon engaging the sidewall, for example, by bending or flexing at least partially outwardly. In this embodiment, the resilient elements 62 are provided on either side of a central line of the tongue 44 and are thus adapted to bend outwardly away from one another. In this configuration, the resilient elements 62 can define partial shoulders configured to block movement of the ring body 32 relative to the fondue pot. Upon opening the tongue 44, the resilient elements 62 are configured to revert to their initial configuration, as seen in FIG. 6A. It is thus noted that the blocker 60, the latch and the engagement member of each clip can cooperate to secure the ring body to the fondue pot.

It is appreciated that the engagement member 56 (e.g., the projection 58) can correspond to an axial lock configured to prevent axial movement of the ring body, such as along a centerline of the ring body and/or along a longitudinal axis of the generally cylindrical fondue pot. For example, the axial lock can block vertical movement of the ring body relative to the fondue pot. Additionally, the blocker 60 (e.g., the resilient elements 62) can correspond to a rotational lock or radial lock configured to prevent rotational movement of the ring body relative to the fondue pot. Therefore, it is noted that blocking both the axial movement and the radial movement of the ring body relative to the fondue pot secures the adapter ring to the fondue pot.

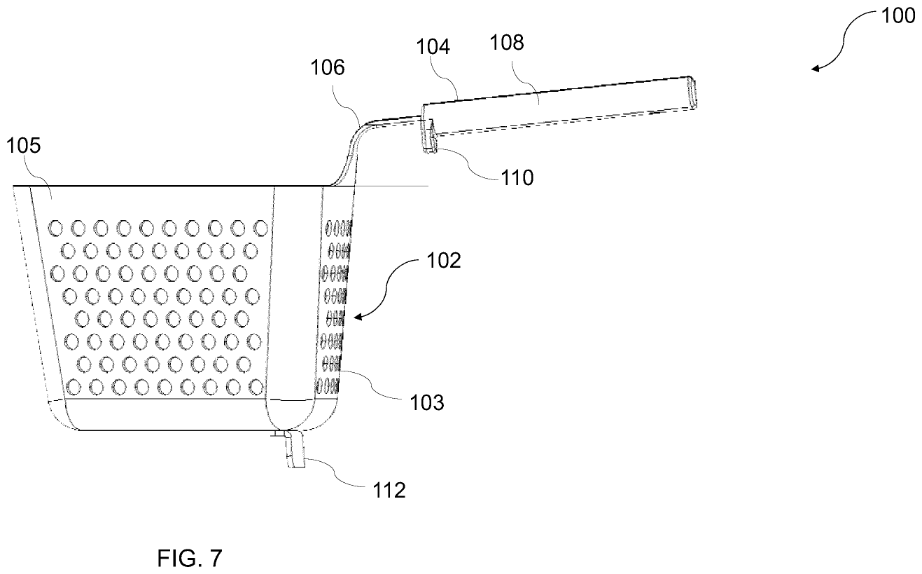

Now referring to FIG. 7, in addition to FIG. 3, the adapter ring 30 includes holding sections 34 for the baskets 100 to be mounted thereon. In this embodiment, each basket 100 includes a perforated and generally triangular basket body 102 having a perforated handle-facing side 103 connected by two perforated lateral sides 105. The corners connecting the perforated sides may be rounded corners. The perforations of the basket body 102 allow liquid to flow into the basket when submerged in a cooking liquid, for example, and to drain therefrom when the basket 100 is removed from the pot. The triangular body 102 of the baskets 100 can correspond to a portion of the generally circular fondue pot 14. For example, the triangular body can be complementarily-shaped relative to the portion of the fondue pot and define an arc section of about 60 degrees, such that six (6) baskets 100 can fit together within the pot 14 (which has a 360 degrees opening). It is appreciated that other configurations are possible, such as having four (4) 90-degree baskets, or nine (9) 40-degree baskets, for example. The baskets 100 may be shaped and sized so that there is leeway (e.g., s gap) between the baskets 100 to facilitate placing and/or removing baskets from the pot.

Still referring to FIG. 7, the basket can include a handle 104 having a shoulder 106 extending upwardly and outwardly from the basket body 102 and a gripping portion 108 at a distal end of the handle 104. In the illustrated embodiment, the basket body 102 and the handle 104 can have an integral metallic construction, with the gripping portion surrounding the distal end of the metallic construction. It should be understood that the gripping portion can be made of a material having low thermal conductivity that the user may grip during handling of the basket 100. In the illustrated embodiment, the gripping portion 108 includes a tab 110 adapted to assist in positioning the basket around the fondue pot.

In some embodiments, the basket 100 additionally includes a bottom hook member 112 extending downwardly from the basket body 102 proximate the perforated handle-facing side 103 to assist in positioning the basket around the fondue pot. For example, the fondue pot can be provided with a circumferential groove or abutment (not shown) along the bottom surface with which the bottom hook member 112 can engage. Alternatively, or additionally, and with reference to FIGS. 3 and 7, the adapter ring 30 can include basket sockets 115 provided along the inner ring section. In some embodiments, the bottom hook member 112 can be adapted to engage with (e.g., be inserted in) a corresponding bracket socket 115 to maintain the basket 100 in an elevated position (e.g., cooling position), such as above the heated contents of the fondue pot. The basket 100 may additionally include a top hook member (not shown) proximate the handle to further assist in positioning the basket within the fondue pot, such as in a cooking position.

With continued reference to FIGS. 3 and 7, in this embodiment, the holding sections 34 of the adapter ring 30 each include a recess 70 shaped and sized to receive at least a part of the of the basket 100 in order to hold it in a predetermined position around and within the fondue pot. The recess 70 can include a top portion 72, defined at least partially on a top surface of the ring body 32. and a lateral portion 74, defined at least partially on a lateral surface of the ring body 32 (e.g., the outer ring surface 39). The top portion 72 can be adapted to receive and support the shoulder 106 of the basket 100, with the recessed configuration of the top portion 72 assisting in preventing movement of the handle 104, such as along the circumferential direction C (see FIG. 6). Similarly, the lateral portion 74 is configured to have the tab 110 of the handle abut thereon to assist in preventing movement of the handle 104, such as along a radial direction R. It is thus appreciated that the top and lateral portions of the recess permit restricting the position of each basket 20 to a predetermined location or area around the fondue pot.

It should be appreciated from the present disclosure that the various embodiments of the fondue assembly enable easier operation and use of the fondue assembly. The adapter ring can be coupled to the fondue pot by operating clips disposed about an outer periphery thereof. The clips are configured to engage the fondue pot to block, or at least restrict, movement of the adapter ring relative to the fondue pot. In other words, the clips are operable to lock the adapter ring to the fondue pot. The adapter ring is also configured to cooperate with the fondue pot to define predetermined basket locations, and to assist in maintaining the baskets in said predetermined locations. The shape and size of the basket handle is configured to engage the adapter ring to keep the baskets in their desired positions. Furthermore, additional features of the basket (e.g., the top and/or bottom hooks) allow the baskets to sit inside the fondue pot, or elevated above the interior volume of the fondue pot, adjacent to other baskets to enable generally hassle-free cooking of the contents of the basket (e.g., with reduced risks of losing food within the fondue pot, or of mixing food with another basket, etc.).

Referring back to FIGS. 4A and 4B, the adapter ring can include additional features and/or components to facilitate operation thereof. For instance, the outer ring section 38 can be adapted to overhang the lip 20 of the fondue pot, thus defining a space 80 between the sidewall 16 and the outer ring section. This space 80 can be sufficient, for example, to facilitate gripping and manipulating the adapter ring from outside (i.e., from an environment surrounding the adapter ring). More specifically, the space 80 can enable a user to insert one or more fingers beneath the adapter ring within the space to provide a better grip. Similarly, in some embodiments, the inner ring section 36 can include a double-wall 82 configuration to facilitate gripping and manipulating the adapter ring from inside the fondue pot. The double-wall can include a first wall 84 and a second wall 86 spaced from one another to define an overall thickness of the inner ring section 36 and/or a groove 88 therebetween. The adapter ring can thus be gripped from below, from outside (e.g., via the space 80) and/or from inside (e.g., via the thickness and/or the groove).

The present disclosure may be embodied in other specific forms without departing from the subject matter of the claims. The described example embodiments are to be considered in all respects as being only illustrative and not restrictive. For example, the fondue pot may not be provided with a lip. In such a “lipless” configuration, the clips can be configured to engage directly with the sidewall of the fondue pot to lock the adapter ring in place. Furthermore, in the illustrated embodiments, the adapter ring comprises four (4) clips provided about the outer ring section. However, it is appreciated that any other suitable number of locking elements can be provided to enable securing the adapter ring to the fondue pot. Moreover, the locking elements can be provided at any suitable interval about the ring body, such as at regular interval, non-regular intervals, in a symmetrical pattern, in an asymmetrical pattern and/or any combination thereof, for example. In other embodiments, the clips can be alternatively, or additionally, provided along the inner ring section.

It is also noted that the ring body of the adapter ring can be formed of a single monolithic piece. It should be noted that, as used herein, the expression “monolithic piece” can refer to a part of piece which does not include interconnected and disconnectable parts forming a whole, but rather a one-piece unit. The monolithic piece can have different portions or sections, although the different portions cannot be disconnected from one another as they are part of the same monolithic structure. In such embodiments, the clips are pivotally coupled within respective openings defined along the monolithic ring body. In some embodiments, the ring body can be manufactured using an additive manufacturing process, such as 3D printing, for example. It should be noted that different parts of the described system can be manufactured using similar processes. Alternatively, the ring body can be formed using any other suitable manufacturing process, and can be formed of several (e.g., two or more) pieces connected together.

In other possible embodiments, each clip can include a latch, an engagement member and a blocker. However, it should be appreciated that the clips can alternatively include any suitable combination of these features (e.g., blocker only, latch only, latch and blocker, but no engagement member, etc.). Additionally, it is noted that the blocker, as disclosed herein, can be adapted to extend from the latching protrusions of the latch. In such embodiments, the latch would therefore be configured to block both axial and rotational movement of the adapter ring. The clips can include any other suitable feature, such as springs, for example. The adapter ring can be connected to the fondue pot via various different mechanisms and/or combination thereof. For instance, the adapter ring and fondue pot can be provided with complementary grooves or threads enabling the adapter ring to be connected to the fondue pot via a rotation movement (e.g., the adapter ring can be at least partially screwed onto the fondue pot). The locking mechanism can then be operated to secure the adapter ring in place. Other connection means and/or methods are also possible.

As used herein, the terms “coupled”, “coupling”, “attached”, “connected” or variants thereof as used herein can have several different meanings depending in the context in which these terms are used. For example, the terms coupled, coupling, connected or attached can have a mechanical connotation. For example, as used herein, the terms coupled, coupling or attached can indicate that two elements or devices are directly connected to one another or connected to one another through one or more intermediate elements or devices via a mechanical element depending on the particular context.

In the present disclosure, an embodiment is an example or implementation of the fondue assembly. Appearances of “one embodiment,” “an embodiment” or “some embodiments” do not necessarily all refer to the same embodiments. Although various features may be described in the context of a single embodiment, the features may also be provided separately or in any suitable combination. Reference in the specification to “some embodiments”, “an embodiment”, “one embodiment”, or “alternative embodiments”, means that a particular feature, structure, or characteristic described in connection with the embodiments is included in at least some embodiments, but not necessarily in all embodiments.

Positional descriptions such as “radial”, “inward”, “outward”, “top”, “bottom”, “peripheral”, “internal”, “external”, and the like should, unless otherwise indicated, be taken in the context of the figures and should not be considered limiting. Furthermore, in the context of the present disclosure, it will be considered that all elongated objects and/or circular objects will have an implicit “longitudinal axis” or “centerline”, such as the centerline of the ring body, for example, or the longitudinal axis of the generally cylindrical fondue pot.

In the above description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The implementations, geometrical configurations, materials mentioned and/or dimensions shown in the figures are optional, and are given for exemplification purposes only.

In addition, although the optional configurations as illustrated in the accompanying drawings comprise various components and although the optional configurations of the fondue assembly as shown may consist of certain geometrical configurations as explained and illustrated herein, not all of these components and geometries are essential and thus should not be taken in their restrictive sense, i.e., should not be taken as to limit the scope of the present disclosure. It is to be understood that other suitable components and cooperations thereinbetween, as well as other suitable geometrical configurations may be used for the implementation and use of the fondue assembly, and corresponding parts, as briefly explained and as can be easily inferred herefrom, without departing from the scope of the disclosure.

1. A fondue assembly, comprising:
a heating device operable to generate heat;
a fondue pot adapted to be mounted on the heating device for receiving heat therefrom, the fondue pot having a peripheral wall provided with a lip defined at a top edge thereof;
an adapter ring adapted to be coupled to the fondue pot, the adapter ring comprising:
a ring body having an inner ring section and an outer ring section coupled together to form a generally U-shaped cross-section, the ring body being adapted to engage the top edge of the fondue pot to position the inner ring section within the fondue pot and to position the outer ring section along an outside of the fondue pot; and
a locking mechanism operatively coupled to the ring body and comprising a locking element operable between a locked configuration, where the locking element is adapted to engage the lip of the fondue pot to secure the ring body relative to the fondue pot, and an unlocked configuration, where the locking element is spaced from the lip of the peripheral wall to enable movement of the ring body relative to the fondue pot; and
at least one basket adapted to cooperate with at least one of the adapter ring and the fondue pot in order to be positioned in a predetermined position relative to at least one of the adapter ring and the fondue pot.

2. The fondue assembly of claim 1, wherein the lip of the peripheral wall extends from the top edge thereof at an angle between about 60 degrees and about 120 degrees.

3. The fondue assembly of claim 1, wherein the lip of the peripheral wall extends outwardly from the peripheral wall, and the outer ring section of the ring body is adapted to overhang the lip, and wherein the locking element is provided along the outer ring section of the ring body and is adapted to engage the lip when in the locked configuration.

4. The fondue assembly of claim 1, wherein the outer ring section comprises a clip opening defined along a length thereof, and the locking element comprises a clip pivotally connected to the ring body within the clip opening, the clip being pivotable between an open position to operate the locking element in the unlocked configuration, and a closed position to operate the locking element in the locked configuration.

5. The fondue assembly of claim 4, wherein the clip comprises a substantially planar body pivotally connected to the ring body at a first end thereof and a projection extending from the planar body, and wherein, upon coupling the adapter ring to the fondue pot, the clip is pivotable in the closed position to position the projection below the lip to prevent upward movement of the ring body relative to the fondue pot, and in the open position to space the projection from the lip and allow disconnection of the adapter ring from the fondue pot.

6. The fondue assembly of claim 5, wherein the clip comprises at least one latching protrusion extending from a rear side of the planar body, and the outer ring section comprises a catching protrusion extending into the clip opening and configured to receive and connect with the latching protrusion to releasably secure the locking clip in the closed position.

7. The fondue assembly of claim 6, wherein the clip opening comprises a pair of catching protrusions extending therein from opposite sides thereof, and the clip comprises a pair of latching protrusions extending from opposite sides of the planar body.

8. The fondue assembly of claim 4, wherein the clip comprises a blocker extending from a rear side thereof and adapted to engage the peripheral wall of the fondue pot when in the closed position, the blocker being configured to at least partially block rotational movement of the ring body relative to the fondue pot when engaging the peripheral wall.

9. The fondue assembly of claim 8, wherein the blocker comprises at least one resilient element configured to apply a compressive force on the peripheral wall when the clip is in the closed position to at least partially block rotational movement of the ring body relative to the fondue pot.

10. (canceled)

11. (canceled)

12. (canceled)

13. (canceled)

14. (canceled)

15. (canceled)

16. The fondue assembly of claim 1, wherein the locking element comprises at least one latching protrusion, and the outer ring section comprises a plurality of catching protrusions, and wherein the at least one latching protrusion is configured to cooperate with one of the plurality of catching protrusions to releasably secure the locking elements in the closed position.

17. The fondue assembly of claim 1, wherein the locking element comprises a blocker extending from the rear side thereof and adapted to contact the peripheral wall of the fondue pot when in the locked configuration, the blocker being configured to at least partially block rotational movement of the ring body relative to the fondue pot when in contact therewith.

18. The fondue assembly of claim 1, wherein the ring body comprises at least one holding section, and wherein the at least one basket comprises a handle adapted to cooperate with the at least one holding section to retain the basket in the predetermined position.

19. (canceled)

20. A fondue assembly, comprising:
a heating device operable to generate heat;
a fondue pot adapted to be mounted on the heating device for receiving heat therefrom, the fondue pot having a peripheral wall provided with a lip defined at a top edge thereof;
an adapter ring connectable to the fondue pot, the adapter ring comprising:
a ring body adapted to engage the lip; and
a locking mechanism operatively coupled to the ring body and being operable between a locked configuration, where the locking mechanism at least partially blocks movement of the ring body relative to the fondue pot, and an unlocked configuration;
at least one basket adapted to cooperate with at least one of the adapter ring and the fondue pot in order to be positioned in a predetermined position.

21. The fondue assembly of claim 20, wherein the locking mechanism comprises an axial locking element configured to at least partially block movement of the ring body along a centerline axis thereof relative to the fondue pot when the locking element is in the locked configuration.

22. The fondue assembly of claim 20, wherein the locking mechanism comprises a rotational locking element configured to at least partially block rotational movement of the ring body relative to the fondue pot.

23. An adapter ring for positioning fondue baskets relative to a fondue pot having a top edge, comprising:
a ring body connectable to the fondue pot along the top edge, the ring body having an inner portion adapted to extend along an inner surface of the fondue pot and an outer portion adapted to extend along an outer surface of the fondue pot; and
a locking mechanism operatively coupled to the ring body and comprising a locking element provided along the outer portion, the locking element being operable between a locked configuration, where the locking element engages the fondue pot proximate the top edge to secure the ring body to the fondue pot, and an unlocked configuration, where the locking element disengages the fondue pot to enable movement of the ring body relative to the fondue pot.

24. The adapter ring of claim 23, wherein the ring body is a single monolithic piece.

25. The adapter ring of claim 23, wherein the outer portion is adapted to overhang the top edge of the fondue pot and define a space between the outer portion and the fondue pot, the space being sized to enable insertion of a finger therein to facilitate gripping the ring body.

26. The adapter ring of claim 23, wherein the outer portion comprises an opening defined along a length thereof, and the locking element is pivotally connected to the ring body within the opening and is pivotable between the locked and unlocked configurations.

27. (canceled)

28. (canceled)

29. (canceled)

30. (canceled)

31. (canceled)

32. (canceled)

33. (canceled)

34. (canceled)

35. (canceled)

36. (canceled)

37. The adapter ring of claim 23, wherein the ring body comprises at least one recess defined along a top surface thereof adapted to receive a portion of a fondue basket, the ring body further comprising at least one socket defined along the inner portion and adapted to receive a hook member of the fondue basket.

38. (canceled)
